(19) United States
(12) Patent Application Publication
(10) Pub. No.: US 2009/0293214 A1
(43) Pub. Date: Dec. 3, 2009

(54) DRAIN CLOG REMOVER AND SHAFT USABLE THEREWITH

(76) Inventors: Bryan L. Ackerman, Freeland, MI (US); Julie L. Bates, Franklin, WI (US); Marc B. Frosch, Racine, WI (US); Jose Porchia, Greenfield, WI (US); David A. Smith, Brookfield, WI (US); John C. Taylor, Kenosha, WI (US); Steven A. Zach, Racine, WI (US)

Correspondence Address: S.C. JOHNSON & SON, INC., 1525 HOWE STREET, RACINE, WI, 53403-2236, US

(21) Appl. No.: 12/474,386

(22) Filed: May 29, 2009

Related U.S. Application Data
(63) Continuation-in-part of application No. 11/746,214, filed on May 9, 2007.
(60) Provisional application No. 61/082,726, filed on Jul. 22, 2008.
(60) Provisional application No. 61/119,134, filed on Dec. 2, 2008.

(51) Int. Cl. B08B 9/00

(52) U.S. Cl. 15/104.05

(57) ABSTRACT

An apparatus for removing drain clog material from a drain pipe assembly. The assembly has: (a) a container, and (b) a shaft. The container defines a reservoir adapted to receive a drain cleaning composition. The container also has an outlet. The shaft is attached to the outlet of the container and is in fluid communication with the container. The shaft also has an X-direction, a Y-direction perpendicular thereto, and a Z-direction perpendicular to both the X- and Y-directions, in addition to a plurality of barbs extending outwardly. The barbs have a force to remove of less than 20 lbs.; and a peak bend force of less than 4 lbs.

### CROSS-REFERENCE TO RELATED APPLICATIONS

This application is a continuation-in-part of prior application Ser. No. 11/746,214, filed May 9, 2007. This application also claims the benefit of U.S. Provisional Application No. 61/082,726, filed Jul. 22, 2008, and U.S. Provisional Application No. 61/119,134, filed Dec. 2, 2008.

### FIELD OF THE DISCLOSURE

The present disclosure generally relates to plumbing maintenance, and more particularly to apparatus and chemical compositions for removing clogs from drain pipes.

### BACKGROUND OF THE DISCLOSURE

Various types of apparatus and chemical compositions are known for removing clogs formed in drain pipes. In some of these, a mechanical apparatus is provided for engaging and removing the clog-forming material from the drain pipe. In one example, the device includes an elongate, flexible strip sized for insertion into the drain pipe. The strip has a length sufficient so that a distal end will contact the clog. The user may then apply pushing, pulling, twisting, or other force to the strip in an attempt to engage and/or dislodge all or part of the clog. The strip may include barbs or other projections extending from an exterior surface to improve the ability to snag or otherwise engage fibrous material that may be stuck in the drain pipe. Once the clog material is engaged, the device is withdrawn from the drain pipe, bringing the clog-forming material with it.

Other types of devices attempt to dislodge the clog by providing a fluid jet that is directed toward the clog. These devices may be connected to a source of pressurized fluid such as water or air, and may include an elongate member having a channel extending therethrough to direct pressurized fluid toward the location of the clog.

Alternatively, various chemical compositions are known which are adapted to disintegrate or dissolve clogs formed in drain pipes. The chemical compositions are typically provided in containers, and the user simply pours the chemical composition from the container into an inlet of the drain. Other chemical dispensing devices may include a tube that is inserted into the drain pipe and through which chemical composition flows via gravity.

While the above-noted mechanical and chemical approaches have met with some success, there is still a need for devices which more quickly and efficiently eliminate clogs from drain pipes.

### SUMMARY OF THE DISCLOSURE

In a first nonlimiting embodiment, the present invention is directed to an apparatus for removing drain clog material from a drain pipe assembly. The assembly has: (a) a container, and (b) a shaft. The container defines a reservoir adapted to receive a drain cleaning composition. The container also has an outlet. The shaft is attached to the outlet of the container and is in fluid communication with the container. The shaft also has an X-direction, Y-direction perpendicular thereto, and a Z-direction perpendicular to both the X- and Y-directions, in addition to a plurality of barbs extending outwardly. The barbs have a force to remove of less than 20 lbs.; and a peak bend force of less than 4 lbs.

In a second nonlimiting embodiment, the present invention is directed to a shaft for use with an apparatus for removing clog material from a drain pipe assembly. The shaft has: (a) an X-direction, Y-direction perpendicular thereto, a proximal end and a distal end, the shaft further comprising a conduit for fluid communication between the proximal end and distal end; and (b) a plurality of projections extending outwardly therefrom.

In a third nonlimiting embodiment, the present invention is directed to a kit for a drain clog remover, the kit has: (i) a chemical means; and (ii) a mechanical means. The mechanical means comprises a shaft, the shaft comprising a plurality of projections that extend outwardly from the shaft. The chemical means and mechanical means are contained in a unitary packaging unit.

### BRIEF DESCRIPTION OF THE DRAWINGS

For a more complete understanding of the disclosed methods and apparatuses, reference should be made to the embodiment illustrated in greater detail on the accompanying drawings, wherein:

FIG. 1 is perspective view of an assembled drain clog remover, constructed according to the present disclosure;

FIG. 2 is an enlarged side elevation view of a portion of a container used in the drain clog remover of FIG. 1;

FIG. 3 is perspective view of an assembled drain clog remover, constructed according to the present disclosure;

FIG. 4 is perspective view of a container for a drain clog remover, constructed according to the present disclosure;

FIG. 5 is perspective view of an assembled drain clog remover as it may be used in a drain pipe assembly according to the present disclosure;

FIG. 6 is a top view of a shaft for a drain clog remover, constructed according to the present disclosure;

FIG. 7 is a cross-sectional view of a shaft for a drain clog remover, taken along line 7-7 of FIG. 6, constructed according to the present disclosure;

FIG. 8 is a cross-sectional view of an alternative embodiment of a shaft for a drain clog remover, constructed according to the present disclosure.

FIG. 9 is a cross-sectional view of an alternative embodiment of a shaft for a drain clog remover, constructed according to the present disclosure.

FIG. 10 is a perspective view of an exemplary embodiment of a shaft having a plurality of barbs.

FIG. 11 is a perspective view of an exemplary embodiment of a test system according to the present disclosure.

FIG. 12 is a perspective view of an exemplary embodiment of a test system according to the present disclosure.

FIG. 13 is a perspective view of an exemplary embodiment of a test system according to the present disclosure.

FIG. 14 is a perspective view of an exemplary embodiment of a shaft according to the present disclosure.

FIG. 15 is a perspective view of an exemplary embodiment of a shaft according to the present disclosure.

FIG. 16 is a perspective view of an exemplary embodiment of a shaft according to the present disclosure.

FIG. 17 is a perspective view of an exemplary embodiment of a shaft according to the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

### Definitions

As used herein, the term “drain cleaning composition” encompasses any liquid, gel, or solid material, other than water or water from a plumbing supply (e.g. softened water; hard water), or combination thereof, which is used or marketed for use to remove drain clogs and/or to protect against drain clogs. Exemplary drain cleaning compositions include, but are not limited to, caustic materials such as sodium hydroxide, mixtures of sodium hydroxide, metal (e.g. aluminum) chips, and sodium nitrate, or alkaline sodium hypochlorite solutions (e.g. U.S. Pat. No. 4,080,305), as well as other cleaners such as laundry bleach or those with additives such as surfactants, proteolytic enzymes, and disulfide reducing agents. See e.g. U.S. Pat. Nos. 4,540,506, 4,619,710 and 3,503,890.

Drain clog removers are disclosed herein for removing clog-forming material from drain pipes. The drain clog removers may advantageously engage the clog both mechanically and chemically, thereby to efficiently remove the clog.

As used herein, the term “chemical means” encompasses any composition or non-mechanical element(s) which may be used to remove a drain clog. A nonlimiting example of a chemical means for drain clog removal is the Drano® Max product available from the S.C. Johnson & Son. Co. (Racine, Wis.).

As used herein, the term “mechanical means” encompasses any physical element(s) which may be used to remove a drain clog. Nonlimiting examples of mechanical means for drain clog are described in U.S. Pat. Nos. 6,775,873, 6,698,317, and 6,363,566.

As used herein, the term “clog forming material” refers to any material, which includes, but may not be limited to, fibrous material such as hair or other natural fibers. It is thought that such clog forming material may accumulate in a drain pipe assembly and consequently obstruct flow in the drain pipe assembly.

As used herein, the term “compatible with a drain pipe assembly” refers to any mechanical means for removing clog forming material wherein the mechanical means may be inserted into, and relatively easily removed from, the drain pipe assembly. In one embodiment, a mechanical means that is compatible with a drain pipe assembly comprises an X-direction, Y-direction perpendicular to the X-direction, and a Z-direction perpendicular to both the X- and Y-directions.

As used herein, the phrase “adapted to grip” includes structures that may engage, snag, or otherwise hold or secure materials that may form a clog in drain pipes.

### Combined Mechanical and Chemical Drain Clog Remover

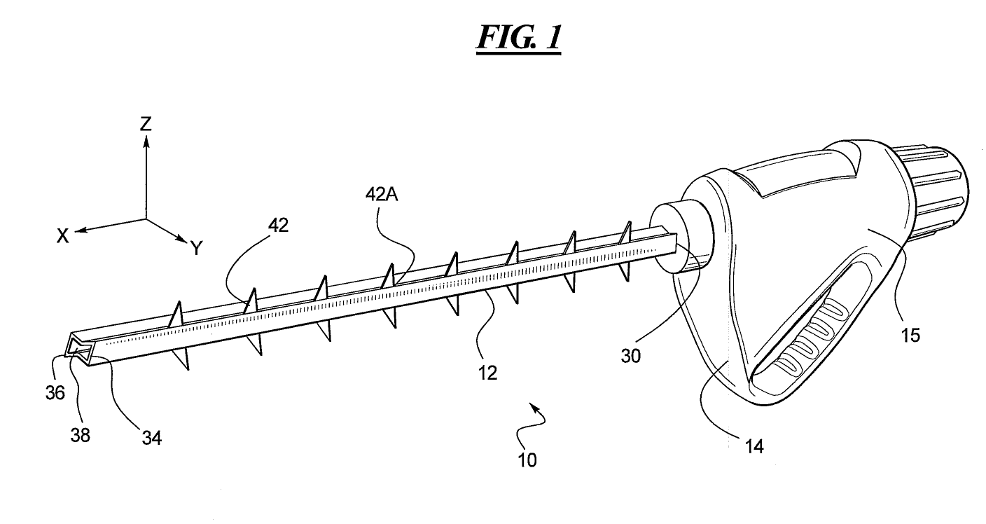

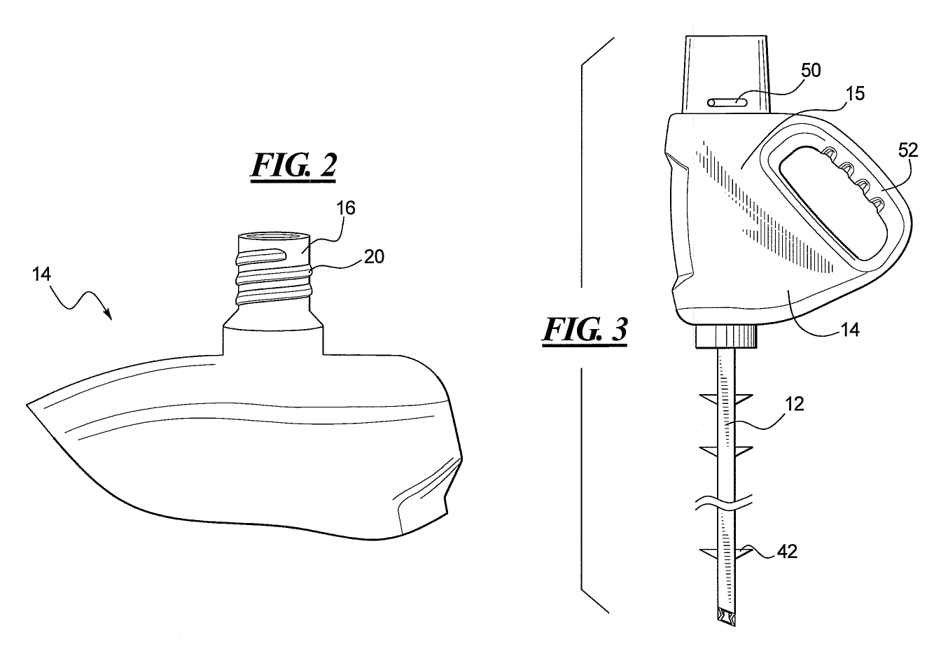

Referring to FIG. 1, an exemplary embodiment of a drain clog remover 10 is shown having a shaft 12 coupled to a container 14 holding a drain cleaning composition 15. As is better exemplified in FIG. 2, the container 14 includes, inter alia, a discharge stem 16 defining an outlet 18 for dispensing the composition 15. An exterior of the discharge stem (FIG. 2) 16 is formed with external threads 20 that are complimentary to internal threads (not shown) formed in the shaft 12 for releasably coupling the shaft 12 to the container 14. It will be appreciated, however, that any known form of coupling the shaft 12 to the container 14, whether permanent or removable, may be used without departing from the scope of this disclosure.

### Container

As may be exemplified in FIG. 2, a container 14 may comprise a valve (not shown). In the exemplified embodiment, the valve is a tilt valve assembly. Such a valve may be used to selectively control the flow of chemical composition 15 (FIG. 3) through the discharge stem 16. For example, when the discharge stem 16 is in a normal, undeflected position as shown in FIG. 1, the tilt valve assembly is closed to prevent flow through the discharge stem 16. In one example, the discharge stem 16 may be deflected in a lateral direction to an actuated position in which the discharge stem 16 is tilted with respect to the container 14. In the actuated position, the tilt valve assembly may be opened to allow the chemical composition 15 to flow from the container and through the discharge stem 16. In one nonlimiting embodiment, the container 14 may also include a propellant that pressurizes the interior of the container 14, thereby to assist with the discharge of the composition 15 when the tilt valve assembly is open. The propellant may be provided inside or otherwise dissolved within the composition, or may reside within the container 14 separately from or otherwise unmixed with the drain cleaning composition.

While the container 14 has been described herein as a pressurized aerosol can having a tilt valve, it will be appreciated that a variety of other types of containers or reservoirs may be used. The container may be formed of metal, plastic, or any other material suitable for holding the drain cleaning composition. Regardless of the material used, the walls of the container may be rigid or flexible. Other types of valves may be substituted for the tilt valve assembly, or the valve may be omitted from the container 14 altogether.

The container may include a propellant as described above, may be provided with mechanical means for increasing the interior pressure of the container 14 (such as a piston or plunger), or may omit any pressurization of the container interior and instead rely on gravity, manual force, or other means to dispense the composition. For example, one possible alternative to the illustrated container 14 may be a flexible plastic pouch having a frangible seal across the outlet. Upon application of manual pressure to an exterior of the flexible pouch, the seal may break to allow the composition to flow through the outlet. In this alternative example, the manual pressure not only opens the seal but also pressurizes the interior of the pouch to discharge the composition with additional force.

As understood from the foregoing examples, the container 14 may be designed for repeated use or may be intended to be disposable after a single use. Furthermore, any container 14 may hold any chemical composition that is known to dissolve, break-up, or otherwise remove clog-forming material in drain pipes.

### Shaft: Chemical Delivery System

The shaft 12 allows a user to manually remove drain-clogging material while providing a conduit to provide a relatively precise directional guidance of the composition 15 to the desired location within a drain pipe. As is exemplified in FIG. 1, the shaft 12 includes a proximal end 30 which may comprise internal threads (not shown) for engaging the external threads 20 formed on the discharge stem 16. Opposite the proximal end 30 is a distal end 34. In the exemplary embodiment shown in FIG. 1, the distal end 34 has an angular form to provide a relatively abrupt point 36 at the distal end 34. In the illustrated embodiment, a delivery passage 38 extends through an interior of the shaft 12 from the proximal end 30 to an outlet formed at the distal end 34. Alternatively, the delivery passage 38 may terminate at an intermediate point short of the distal end to communicate with one or more outlets formed through a side of the shaft 12. Additionally, the shaft may include multiple outlets formed along its length, with or without the distal outlet formed at the distal end 34. The delivery passage 38 is sized at the proximal end 30 to receive the discharge stem 16, thereby placing the discharge stem 16 in fluid communication with the delivery passage 38. In one embodiment, the shaft 12 extends past any plug or stopper member associated with the drain pipe. In other nonlimiting embodiments, the shaft 12 may be 6″, 12″, 18″ or other length. While the shaft 12 is illustrated as being threadably, and therefore releasably, attached to the container 14, it will be appreciated that the shaft 12 and container 14 may be coupled by friction fit or other releasable coupling. In other embodiments, the shaft 12 may be integrally built into the container 14 or may be adhesively, weldedly, or somehow otherwise permanently attached to the container 14.

The shaft 12 includes projections 42 that are adapted to grip clog-forming material located within the drain pipe. As exemplified in FIG. 1, the projections 42 extend from an exterior surface 40 (FIG. 1) of the shaft 12. In the exemplary embodiment, the projections are formed as barbs 42 that extend outwardly in the Y-Z plane. The barbs 42 may form an acute angle with respect to the base of the barb 42A and the axis of the shaft 12 (as shown in FIG. 1, parallel to the z-axis). In other embodiments, the barbs 42 may form a relatively right, and/or even an obtuse angle with the axis of the shaft 12 depending on the specific needs that one of skill in the art would require for the particular shaft. Surprisingly, it is discovered that the extensions 42 need not be particularly jagged or sharp. In one embodiment, the extensions 42 are relatively rounded and may have a radius of curvature (R_{ext.}, as shown in FIG. 18) of from about 0.01″ to about 0.10″. In another embodiment, the extensions 42 may have a radius of curvature of from about 0.04″ to about 0.07″.

Surprisingly, even without a sharp end point, the barbs 42 are particularly suited for gripping clog materials, such as hair, that may be lodged in the drain pipe. It is thought that a user may lower the shaft 12 into a drain, causing the barbs 42 to engage clog materials, and then subsequently remove the clog materials from the drain upon withdrawal of the shaft 12 from the drain. In some embodiments for usage, a user may agitate or otherwise mechanically disturb the clog material to help loosen, or otherwise disengage it, to provide a relatively optimal usage.

In other embodiments, it is envisioned that structures may be used such as hooks, bristles, bumps, or other extensions that may be suitable for engaging clog material. One of skill in the art may appreciate that the distal end 34 may also be used to engage and dislodge drain-clogging material. In one nonlimiting embodiment, one or more projections may further include a projection port in fluid communication with the delivery passage 38 through which fluid may pass in a direction substantially perpendicular to an axis of the shaft.

The shaft 12 may be formed of a flexible material which allows it to be bent into an arcuate shape so that it can traverse a tortuous path, such as those commonly presented by typical P-trap and U-trap drain pipes. Accordingly, the shaft 12 may be formed of any flexible or semi-flexible metal, plastic, or other material, such as polypropylene, polyethylene, polyethylene terephthalate, high density polyethylene, low density polyethylene, or similar material.

In a nonlimiting embodiment shown in FIG. 3, the shaft 12 may further include an activation device, or other mechanism or system, such as a button, twist-release, or other suitable assembly 50, to facilitate actuation of the device. Other exemplary actuation systems are described in U.S. patent application Ser. No. 11/746,214.

Yet another alternative embodiment of a drain clog remover 10 is illustrated in FIG. 3. The exemplified drain clog remover 10 includes a container 14 containing a drain cleaning composition 15. In the exemplary embodiment the container 14 further includes a handle 52.

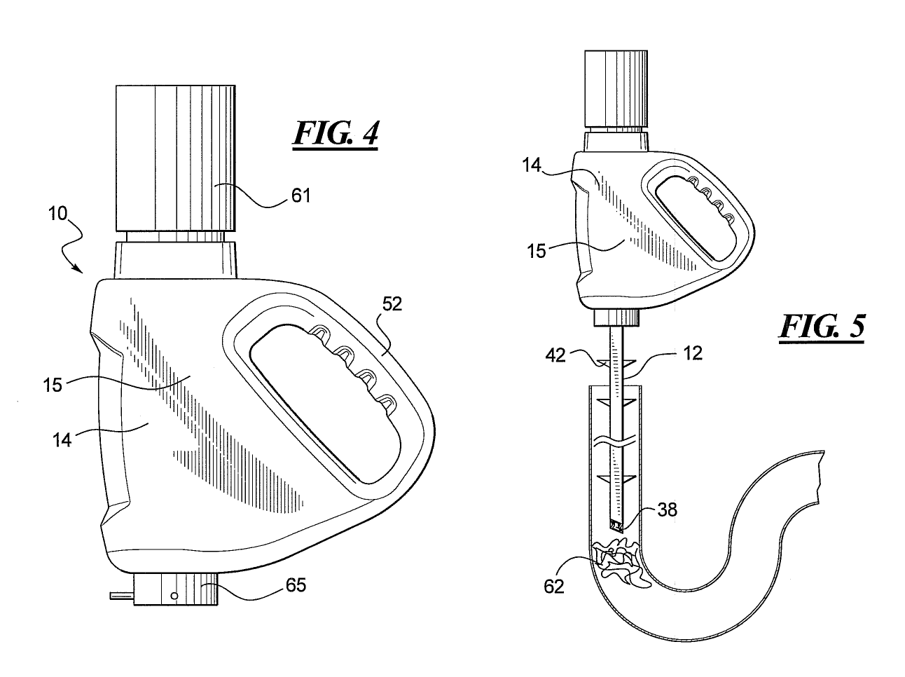

FIG. 4 shows an alternative embodiment in which a pressurization sub-assembly 61 is operatively coupled to the container 14. In one embodiment, the pressurization sub-assembly 61 is in fluid communication with the container. In the exemplary embodiment shown in FIG. 5 the pressurization sub-assembly 61 may be actuated by turning the sub-assembly 61 from a “closed” to an “open” position (not shown) and then depressing the top of the sub-assembly. An exemplary embodiment of such a mechanism is described in greater detail in U.S. patent application Ser. No. 11/746,214.

A shaft (not shown) may be coupled to a connective assembly 65 to provide fluid communication between the container 14 and the shaft. As described above, the shaft may be sufficiently flexible to bend as needed to traverse a drain pipe and the shaft may include projections that are adapted to grip clog-forming material located in the drain pipe.

### Method for Using Drain Clog Removal Device

In operation, the drain clog remover 10 provides mechanical and chemical actions to remove a clog or clog material 62 formed in a drain 60 (FIG. 5). While holding the container 14, the user may insert the shaft 12 into the drain until the shaft distal end 34 engages the clog material 62. When the shaft 12 is formed of a flexible material, it may traverse a tortuous path before it engages the clog. As described above, the shaft 12 may be manipulated within the drain to contact and dislodge all or a portion of the clog by moving the container 14. With the shaft 12 still positioned inside the drain and the distal end 34 adjacent the clog, the user may then actuate the valve assembly to discharge the drain cleaning composition 15 from the shaft 12. The composition 15 travels through the delivery passage 38 and is discharged from the distal end 34 of the shaft 12. As a result, the composition 15 is more accurately dispensed in the immediate vicinity of the clog. After waiting a specified time to allow the composition 15 to sufficiently dissolve or break-up the clog, the user may then flush out the drain with a flow of water. It will be appreciated, therefore, that both mechanical and chemical actions are used to remove the clog from the drain.

Further, in another embodiment, the drain clog remover 10 is provided with a bag for containment and/or disposal of the drain clog remover 10 once the drain clog remover 10 has been used.

### Shaft: Mechanical Properties

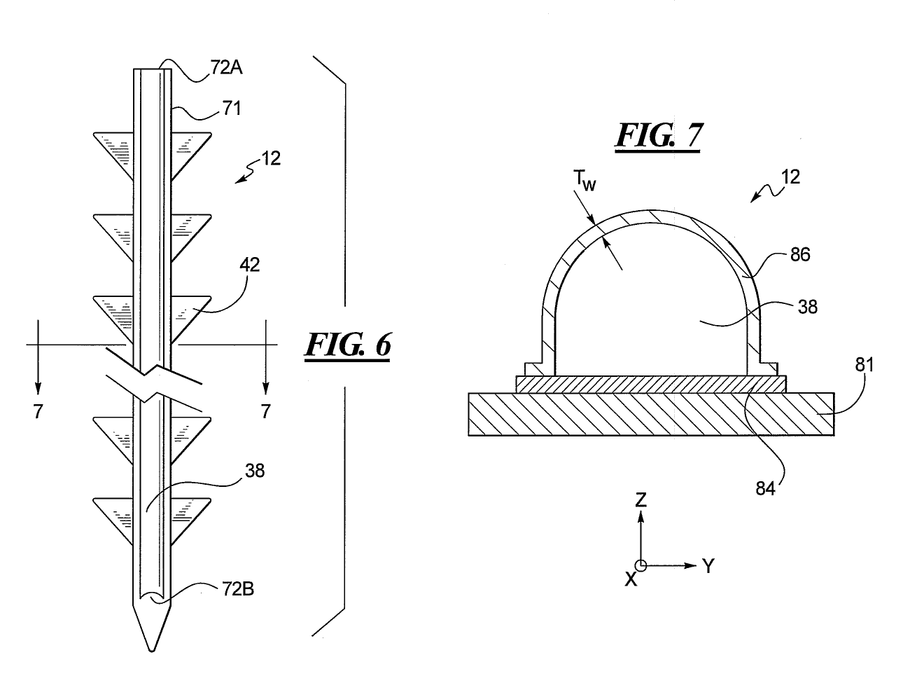

An exemplary shaft 12 is illustrated in FIGS. 6 and 7 for use in any of the foregoing drain clog remover embodiments. The shaft 12 defines a delivery passage 38 through which a chemical composition, for example, may flow while also providing a relatively rigorous structure for mechanically engaging clog material lodged in a drain pipe. As described in greater detail below, in some embodiments the shaft 12 includes a collapsible member that facilitates insertion through narrow openings, such as the space between a drain pipe inlet and an adjustable stopper disposed therein.

In FIG. 6, the exemplary shaft 12 includes an adapter 71 having an inlet end 72A configured for attachment to a discharge outlet of a container, for example, a container as described infra. The exemplary shaft 12 further comprises an outlet end 72B. An internal passage (not shown) extends through the adapter 71 to provide for fluid communication between a bottle and the shaft 12. As described throughout, the shaft 12 and/or the adapter 71 may be relatively flexible so as to allow the shaft 12 to traverse the path of a drain pipe, which may include arcuate bends. As described supra, the shaft 12 may further comprise a delivery passage 38.

FIG. 7 describes an exemplary cross-sectional view of the shaft 12 of FIG. 6 taken along the line 7-7. The shaft 12 comprises a base section 81 and a central section 86. The shaft 12 may further comprise an optional connective layer 84 which may be an adhesive or other material which may couple the base section 81 and the central section 86. A delivery passage 38 may be provided within the hollow volume between the central section 86 (or in the optional embodiment, the connective layer 84), to provide for fluid communication between the container (not shown in FIG. 7) and the shaft 12 through to the drain clog material (not shown) which may be situated at the distal end 34 (FIG. 6) of the shaft 12. It is thought that by providing such a delivery passage 38, the drain clog remover may provide both a mechanical (in the form of the shaft 12 and barbs 42) and chemical (in the form of a drain cleaning, or other chemical, composition) to the drain clog material. In an alternative embodiment, the drain clog material may be addressed mechanically in at least two forms with the shaft 12 and barbs 42 and using a high pressure air (or other non-reactive gas composition) which may be attached to, and in fluid communication with, the shaft 12. The drain cleaning device may be assembled according to any means known to those of skill in the art.

Without wishing to be limited by theory, it is thought that the base section 81 of the shaft 12 may be formed of a base material that is sufficiently rigid to transfer a manual force applied to the flange during use, yet is sufficiently flexible to bend along the drain pipe path. A “Shaft Flex Test” (described below) is used to determine the peak bend force (“PBF”) that is required to bend a shaft 12 at different radiuses. Shafts tested include: a commercially available mechanical drain clog remover “Zip It®” (Cobra Products, Swedesboro, N.J.); an exemplary embodiment of the present invention comprising a rounded central section; and an exemplary embodiment of the present invention comprising an accordion-like central section (described in greater detail infra). Shafts having various geometries are also tested and described below. In one embodiment, the PBF is less than about 4. In another embodiment, the PBF is from about 2-4. In still another embodiment, the PBF is from about 3-4.

Additionally, a “Shaft Break Test” (described in greater detail below) may be used to calculate the force required to break a shaft. In one embodiment, the force to break (“FTB”) is less than about 100. In another embodiment, the FTB is from about 50 to about 100. In still another embodiment, the FTB is from about 50 to about 60.

Surprisingly, it is discovered that by providing PBF and FTB properties within the described ranges, there is an advantage provided to the producer in terms of relatively reduced packaging and costs and further, there is an advantage provided to the consumer, or final user, because such a shaft 12 provides relatively easy movement through the plumbing, especially the U-bend, of a drain.

Nonlimiting examples of suitable materials for the base section and central section, include a monolayer or blend of LLDPE, LDPE, and HDPE, or coextruded with any of these polyethylenes. As described above, projections 42, extend outwardly from the lateral edges 12a, 12b (FIG. 6) of the shaft 12. In one embodiment the base section 81 may also be made of a material that may be selected such that the barbs 42 do not deform when they are engaged with a clog and a manual pulling force is applied, but wherein the material is sufficiently flexible to permit the base section 81 to deform as it is inserted into the drain pipe.

In the exemplary embodiment shown in FIG. 7, the central section 86 is provided with a rounded shape. Without wishing to be limited by theory, it is posited that such a rounded configuration is thought to be relatively compressible (and therefore relatively easy-to-maneuver). In one embodiment, the shaft may have a height (H_{shaft}) of from about 0.003175 m (about ⅛″) to about 0.009525 m (about ⅜″). In one embodiment, the shaft may have a width (W_{shaft}) of from about 0.003175 m (about ⅛″) to about 0.0127 m (about ½″). In another embodiment, the shaft may have a width (W_{shaft}) of from about 0.00635 m (about ¼″) to about 0.009525 m (about ⅜″). As described in other embodiments, at least one delivery passage 38 is provided between the base section 81 and central section 86. In one embodiment, the base section 81 has a base thickness (T_{base}) of from about 0.001016 m (about 0.04″) to about 0.003048 m (about 0.12″). In one embodiment the central section has a wall thickness (T_{wall}) of from about 0.0002 m (about 0.007874″) to about 0.002 m (about 0.07874″). One of skill in the art will appreciate that the cross-sectional area (and subsequently volume) of the delivery passage 38 may be provided such that adequate flow of gas, air, or fluid may have a relatively free means of access through the drain clog remover 10, and in this case, the shaft 12. Further, it is hypothesized that by providing such a relatively small shaft, it is thought that the invention will be able to be used in the greatest number of consumers due to the wide variety of drain configurations that exist. It is thought that providing an overly-large shaft may prevent consumers from effectively being able to take advantage of the product to its fullest.

Similarly, one of skill in the art will appreciate that the optional connector layer 84 may be formed of a connector material that permits materials of disparate and/or similar properties to be joined together. Nonlimiting examples include LLDPE, LDPE, and HDPE.

The optional connector layer 84 may facilitate machine assembly of the shaft 12. For example, the base section 81 and central section 86 may first be extruded and cooled. The optional connector layer 84 may then be extruded and positioned between the base section 81 and the central section 86. The base section 81, central section 86 (and/or optional connection layer 84) may then be brought together so that the molten connector layer adheres the separate pieces together into a unitary structure. In the embodiment shown in FIG. 6, the assembled shaft 12 defines a Ω-shaped conduit through which drain cleaning composition may pass while providing a relatively compressible structure that can fit into, navigate, and then be removed from a drain structure with relative ease.

### Shaft: Unitary Considerations

In addition to providing a central section 86 with a rounded (Ω) shape, it is thought that the actual relationship between the central section 86 and the base section 81 is very important. In some embodiments, the shaft 12 may be constructed from a unitary member that may be made from any suitable technique known in the art, such as blow molding or another molding technique. In an alternative exemplary embodiment, the central section 86 may be directly welded to the base section 81. In doing so, two different materials may be used for the separate sections 81, 86 to provide varying properties in the shaft 12 and/or unique flexibility properties to the shaft 12. One of skill in the art may appreciate that a band of molten polymer, such as polyethylene, may be used to combine the central section 86 and base section 81 together. Surprisingly, it is discovered that the relationship between the properties of the central section 86 and base section 81 is very important and may provide further advantages regarding the bending and flexing of the shaft 12 as the shaft traverses a drain pipe assembly.

For example, in the nonlimiting embodiment of FIG. 7, the central section 86 and the base section 81 may be made of different materials. It is thought that this is beneficial because such a shaft 12 may be provided with, for example, a relatively rigid base section 81 to provide stability to the shaft 12, but the use of a relatively flexible and/or pliable central section 86 allows the shaft 12 to bend and flex. Surprisingly, such a combination allows the shaft 12 to bend and flex, in addition to providing relatively strong support for mechanical removal of drain clog material, without kinking as compared to a shaft 12 made of only one material.

### Shaft: Collapsible Embodiments

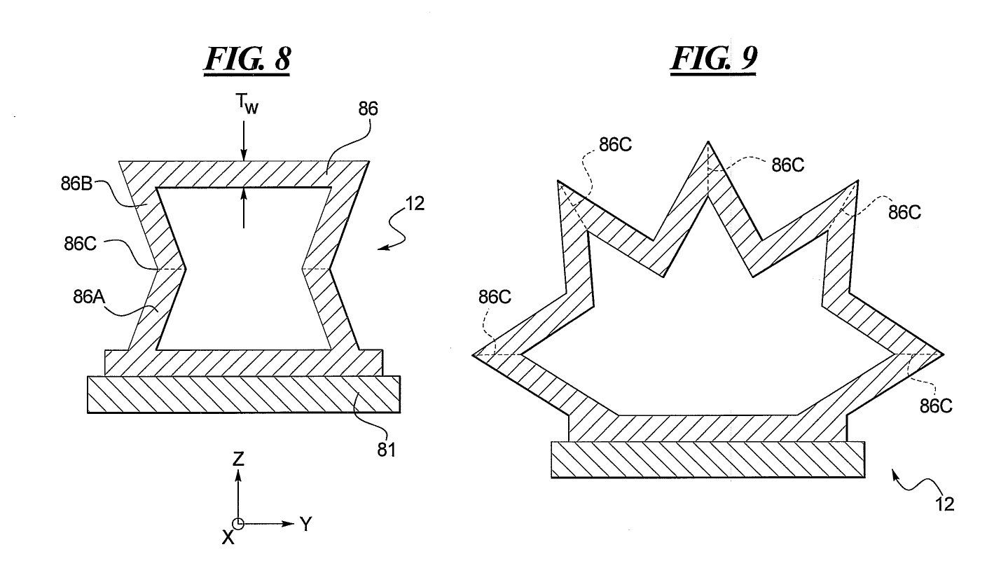

FIG. 8 shows another nonlimiting alternative embodiment of a shaft 12, wherein the shaft 12 comprises a central section 86 and a base section 81 and wherein the central section is compressible. In the exemplary embodiment shown in FIG. 8, the central section 86 comprises at least a first central section 86A and a second central section 86B which are flexibly and/or hingedly attached to each other. It is thought that by providing such a configuration, the shaft 12 will be able to be relatively highly compressible to provide a relative ease of insertion, negotiation, and then removal from a drain pipe assembly. In one embodiment, the first central section 86A and second central section 86B are about the same size. In an alternative embodiment, the first central section 86A and the second central section 86B are different sizes. In one embodiment, the point of flexible attachment 86C extends beyond the plane of the first and/or second central sections (86A, B) of the shaft 12 in the Y-direction. In another embodiment, the point of flexible attachment is juxtaposed within the plane of the first and/or second central sections (86A, B) of the shaft 12. FIG. 9 shows an alternative exemplary embodiment of a shaft 12 having a plurality of points of flexible attachment 86C. One of skill in the art will appreciate that any number of points of flexible attachment may be provided in a shaft 12 to provide the physical properties (such as compressibility) that may be desired in the shaft 12.

In one nonlimiting embodiment, the various central section 86 and base section 81 portions may be made by extruding polymer to provide the desired shape. The shape of the portions may be maintained by running the portions in a wheel which is provided having a hollow area for the portions to fit into. In one embodiment, the central section 86 is guided onto the base section 81 and the two portions may be laminated together using a band of molten polymer, such as polyethylene. The barbs or extensions may be cut from either piece (whichever is desired) using a rotary die cutter.

### Shaft: Projections/Barbs

One of skill in the art will appreciate that as used herein, “projection” may refer to any extension from the shaft which may be used to engage a drain clog material. For example, a projection may be selected from the group consisting of: barbs, hooks, arms, extensions, the like, and combinations thereof. For example, U.S. Pat. No. 6,775,873 describes, inter alia, a unit having a handle, shaft, and projections wherein the projections are at an acute angle. In addition to combining a shaft 12 having projections 42 to be used with a propellant and/or chemical means, the present invention improves upon the prior art by providing projections that have a relatively optimized combination of sharpness, size, flexibility and rigidity. Without wishing to be limited by theory, it is thought that certain barb configurations may provide for relatively easy traversal of the drain and plumbing unit. In particular, it is noticed that certain non-optimized barb configurations may tend to “catch”, or otherwise latch onto, the opening of a drain pipe assembly and require the user to apply an inordinate amount of force to remove the shaft 12. In particular, it is surprisingly discovered that a projection 42 that is too “sharp” or at an overly acute angle tends to catch the drain and is relatively difficult to remove. Even more surprisingly, it is observed that such a configuration does not appear to provide any benefits regarding the removal of clog material from a drain.

Without wishing to be limited by theory, it is thought that providing a barb with a relatively low ability to absorb a shear load, the shaft will be able to be easily removed from a drain pipe assembly in case a barb or extension unexpectedly catches onto some portion of the drain pipe assembly and the user has difficulty removing the unit. A “Barb Strength Test” (described below) may be used to measure the force required to cause a barb to detach, or otherwise break off, from the shaft. In one embodiment, the force to remove a barb is less than about 20. In another embodiment, the force to remove a barb is from about 10 to about 18. In still another embodiment, the force to remove a barb is from about 14 to about 18.

In addition to strength, the geometry of a barb is surprisingly found to have effects beyond the simple ability to “grab” or otherwise secure drain clog material. Surprisingly, it was found that barbs used on exemplary embodiments of the present invention which had two sides which came to an abrupt vertex and/or a vertex formed by an acute angle (i.e., a sharp point) did not pass U.S. CFR Title 16 Part 1500.48-49 (CPSP) regulations. In one embodiment, the barbs of the present invention may be rounded and/or comprise a radius of curvature.

One of skill in the art may appreciate that the barbs 42 may be juxtaposed such that the acute angle formed by the barbs 42 may face either the distal end 34 or proximal end 30.

### Shaft: Alternative Embodiments

FIG. 14 shows an alternative embodiment of a shaft 12 according to the present invention. In the example of FIG. 14, the shaft comprises a relatively wide central section 86 and/or base section 81 having a passage 38. The shaft further comprises one or more recessions 42a into the central section 86 and/or base section 81 which provide a means for engaging drain clog material.

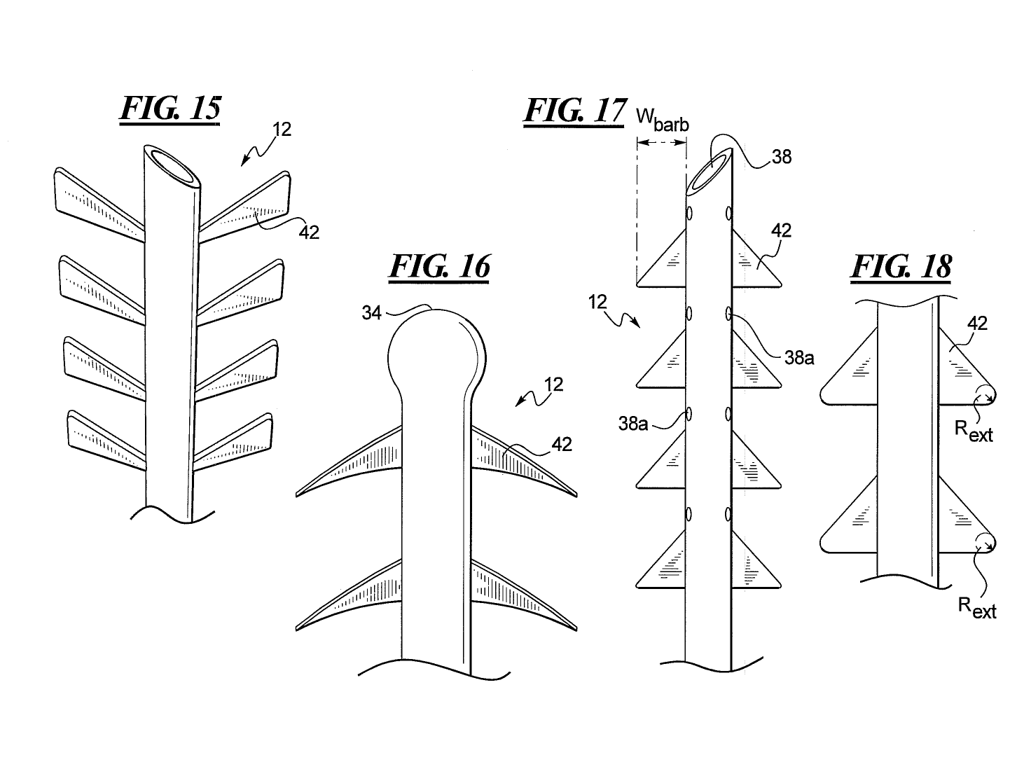

FIG. 15 shows an alternative embodiment of a shaft 12 according to the present invention. In the exemplary embodiment, the shaft 12 comprises a plurality of extensions 42 wherein the extensions 42 comprise a relatively narrow point of attachment to the base section 81 such that the extensions 42 are relatively flexible.

FIG. 16 shows yet another alternative embodiment of a shaft 12 according to the present invention wherein the distal end 34 of the shaft 12 is provided with a rounded shape to provide for relatively easy maneuvering through the elbows and bends of a drain pipe assembly.

FIG. 17 shows still another embodiment, the shaft 12 may comprise a plurality of orifices 38a along its length that may provide for fluid communication between a central passage 38 and various points along the length of the shaft 12.

### Drain Clog Remover Kits

In one embodiment, the drain clog remover 10 may be provided with a storage bag for disposal and/or storage after use. Such a storage bag may be attached using adhesive or any suitable mechanical means to some portion of the drain clog remover 10, such as the container 14. Alternatively, a storage bag may be included with the outerwrap or packaging that is used to display and/or support the drain clog remover 10 while in a retail setting.

In another embodiment, a kit may be provided wherein a drain clog remover 10 comprises a chemical means and a mechanical means which are packaged together. In this embodiment, the chemical means and mechanical means (such as a shaft having projections extending outwardly therefrom) may, or may not, be mechanically or otherwise physically attached to each other. However, such an embodiment wherein both chemical and mechanical means are used and/or packaged in combination are envisioned in the present invention.

### Test Methods

### Barb Strength Test

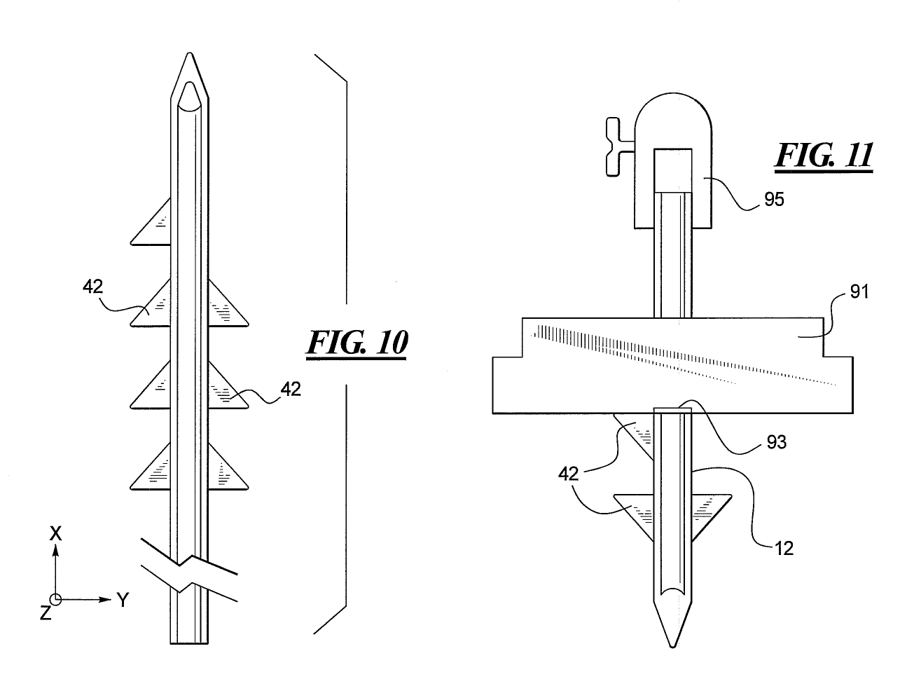

Sample shafts having a length of at least 12 inches and one or more barbs or projections 42 extending outwardly therefrom are labeled. Shafts having multiple barbs 42 at the same position in the X-direction are identified and all but one overlapping barbs 42 are removed using a utility knife. (FIG. 10).

A first test fixture 91 is provided to be used with an Instron Universal Testing Machine Model TT-C retrofitted with a National Instruments USB-6009, 14 bit data acquisition card running LabView software. (not shown) (Instron®, Norwood, Mass.). As exemplified in FIG. 11, the first test fixture comprises an opening 93 that is about the same size as the main body (portion of the shaft without the barbs extending therefrom) of the shaft 12. The opening 93 is sized such that the body of the shaft 12 may fit through the opening without friction or resistance. Accordingly, for the shaft to pass through the opening any barbs 42 must break off first.

The shaft 12 is juxtaposed such that any acute angle formed by the barbs 42 and body of the shaft 12 are facing towards the opening 93. The shaft 12 is passed through the opening 93 of the fixture 91 until the end of the shaft that is being passed through the fixture is able to be secured in the upper jaw of the Instron device (clamp) 95. The shaft is pulled through the opening at a rate of about 5″/minute until the remaining barb 42 on the shaft 12 is broken off. The resultant force required to break the barb is recorded (lbs).

TABLE 1
Barb Strength Test Results

| | Geometry | | | | | |
|---|---|---|---|---|---|---|
| | | | Barb | | | Force to Break Barb |
| Sample | W_{shaft} | H_{shaft} | Width | T_{wall} | T_{base} | (Pounds) |
| Present Invention #1 | 0.285″ | 0.215″ | 0.1675″ | 0.015″ | 0.07″ | 12.3 |
| Present Invention #2 | 0.325″ | 0.234″ | 0.1525″ | 0.022″ | 0.075″ | 31.7 |
| Present Invention #3 | 0.285″ | 0.175″ | 0.17″ | 0.01″ | 0.085″ | 12.8 |
| Present Invention #4 | 0.25″ | 0.225″ | 0.17″ | 0.02″ | 0.07″ | 14.3 |
| Present Invention #5 | 0.25″ | 0.225″ | 0.17″ | 0.02″ | 0.075″ | 13.7 |
| Zip-It ® | 0.25″ | 0.020315″ | 0.25″ | N/A | N/A | 20.5 |

### Shaft Flex Test

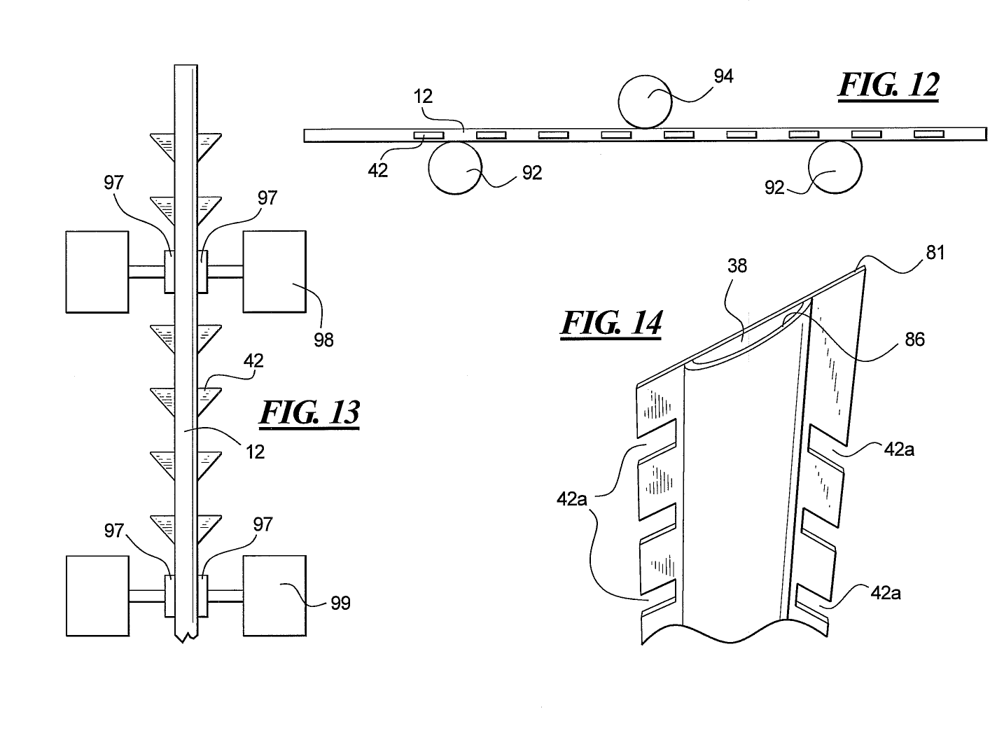

This test is performed in accordance with guidelines outlined in ASTM Method D790 (Flexural Properties of Unreinforced and Reinforced Plastics and Electrical Insulating Materials). FIG. 12 shows an exemplary embodiment of a test fixture that may be used in this test. The exemplary test fixture has two round 0.375″ diameter metal supports 92 that support the test specimen (i.e., shaft 12 with barbs 42) and a third round 0.375″ diameter metal loading nose 94 that applies a load to the shaft. The tests are performed using an Instron Universal Testing Machine Model TT-C retrofitted with a National Instruments USB-6009, 14 bit data acquisition card running LabView software.

The supports are positioned about 2″ apart (from the outer edge of each support, and collinear in the vertical direction FIG. 12) and the loading nose is positioned approximately at the midpoint between the two supports.

A section of a shaft at least 12″ long is placed with on the supports. In the case of a shaft having a central section, the shaft is juxtaposed such that the central section is facing away from the supports. The loading nose is directed towards the shaft at a rate of about 5″/minute to apply a force to the wand. The maximum load that is required to bend the shaft (wherein the load does not increase with an increase in strain) is recorded.

TABLE 2
Shaft Flex Test Results

| | Geometry | | | | | |
|---|---|---|---|---|---|---|
| | | | Barb | | | Peak Bend Force |
| Sample | W_{shaft} | H_{shaft} | Width | T_{wall} | T_{base} | (Pounds) |
| Present Invention #1 | 0.285″ | 0.215″ | 0.1675″ | 0.015″ | 0.07″ | 4.1 |
| Present Invention #2 | 0.325″ | 0.234″ | 0.1525″ | 0.022″ | 0.075″ | 5.1 |
| Present Invention #3 | 0.285″ | 0.175″ | 0.17″ | 0.01″ | 0.085″ | 3.0 |
| Present Invention #4 | 0.25″ | 0.225″ | 0.17″ | 0.02″ | 0.07″ | 4.1 |
| Present Invention #5 | 0.25″ | 0.225″ | 0.17″ | 0.02″ | 0.075″ | 4.1 |
| Zip-It ® | 0.25″ | 0.020315″ | 0.25″ | N/A | N/A | 4.7 |

### Shaft Break Test

The test is performed in general accordance with the guidelines outlined in ASTM D 638 (Tensile Properties of Plastics) using an Instron Universal Testing Machine Model TT-C retrofitted with a National Instruments USB-6009, 14 bit data acquisition card running LabView software. A pair of Instron G-61-1C grips 97, with serrated metal faces are used to attach the sample to the load cell 98 and the movable member 99 of the testing machine (FIG. 13).

The wand is clamped in the grips. The grips are separated at a rate of about 5″/minute until the wand breaks. The force is recorded.

TABLE 3
Shaft Break Test Results

| | Geometry | | | | | |
|---|---|---|---|---|---|---|
| | | | Barb | | | Force to Break Shaft |
| Sample | W_{shaft} | H_{shaft} | Width | T_{wall} | T_{base} | (Pounds) |
| Present Invention #1 | 0.285″ | 0.215″ | 0.1675″ | 0.015″ | 0.07″ | 62.7 |
| Present Invention #2 | 0.325″ | 0.234″ | 0.1525″ | 0.022″ | 0.075″ | 61.4 |
| Present Invention #3 | 0.285″ | 0.175″ | 0.17″ | 0.01″ | 0.085″ | 61.9 |
| Present Invention #4 | 0.25″ | 0.225″ | 0.17″ | 0.02″ | 0.07″ | 53.7 |
| Present Invention #5 | 0.25″ | 0.225″ | 0.17″ | 0.02″ | 0.075″ | 53.9 |
| Zip-It ® | 0.25″ | 0.020315″ | 0.25″ | N/A | N/A | 115.6 |

It is noted that terms like “specifically,” “preferably,” “typically,” “generally,” and “often” are not utilized herein to limit the scope of the claimed invention or to imply that certain features are critical, essential, or even important that certain features are merely intended to highlight alternative or additional features that may or may not be utilized in a particular embodiment of the present invention. It is also noted that terms like “substantially” and “about” are utilized herein to represent the inherent degree of uncertainty that may be attributed to any quantitative comparison, value, measurement, or other representation.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of the invention.

### INDUSTRIAL APPLICABILITY

The apparatus and methods disclosed herein may be used to remove clogs from drain pipes. The drain clog remover includes a container adapted to hold a chemical composition. A shaft is coupled to the container and defines a passage through which the chemical composition may flow. The shaft further includes projections configured to engage a clog and/or provide the user with a relatively easy traversal of the drain pipe. A pressure force is communicated to the interior of the container to discharge the chemical composition. Additionally, the user may manipulate the shaft attached to the container to mechanically engage a clog.

What is claimed is:

1. An apparatus for removing clog material from a drain pipe assembly, the assembly comprising:
a) a container, wherein the container defines a reservoir adapted to receive a drain cleaning composition, the container comprising an outlet; and
b) a shaft, wherein the shaft is attached to the outlet of the container and is in fluid communication with the container, the shaft comprising an X-direction, Y-direction perpendicular thereto, and a Z-direction perpendicular to both the X- and Y-directions:
i) one or more projections extending outwardly; the barbs comprising a force to break of less than 20 lbs.; and
wherein the shaft comprises a peak bend force of less than 4 lbs.

2. An apparatus according to claim 1 wherein the force to break is from about 10 lbs. to about 20 lbs.

3. An apparatus according to claim 1 wherein the peak bend force is from about 2 lbs. to about 4 lbs.

4. An apparatus according to claim 1 wherein the shaft further comprises a force to break of less than about 100 lbs.

5. An apparatus according to claim 1 wherein the shaft further comprises a force to break of from about 50 lbs. to about 100 lbs.

6. A shaft for use with an apparatus for removing clog material from a drain pipe assembly, the shaft comprising:
a) an X-direction, Y-direction perpendicular thereto, a proximal end and a distal end, the shaft further comprising a conduit for fluid communication between the proximal end and distal end;
b) one or more projections extending outwardly therefrom.

7. A shaft for use with an apparatus according to claim 6, wherein the shaft comprises a base section, and a central section;
wherein the base section and central section are sealed along the X-direction.

8. A shaft according to claim 7 wherein the central section comprises a cross-sectional area having an annular shape.

9. A shaft according to claim 6 wherein the shaft further comprises a force to break of from about 10 lbs. to about 20 lbs.

10. A shaft according to claim 6 wherein the shaft further comprises a peak bend force of from about 2 lbs. to about 4 lbs.

11. A shaft according to claim 11 wherein the shaft further comprises a force to break of from about 50 lbs. to about 100 lbs.

12. A shaft according to claim 6 wherein at least one of the one or more projections are rounded.

13. A shaft according to claim 12 wherein at least one of one or more projections have a radius of curvature of from about 0.01″ to about 0.10″.

14. The shaft of claim 7, in which the projections are selected from the group consisting of: barbs, hooks, arms, extensions, the like, and combinations thereof.

15. A kit for a drain clog remover, the kit comprising:
i) a chemical means;
ii) a mechanical means;
wherein the mechanical means comprises a shaft, the shaft comprising one or more projections that extend outwardly from the shaft;
and wherein the chemical means and mechanical means are contained in a unitary packaging unit.

16. A kit for a drain clog remover according to claim 15 wherein the shaft further comprises a proximal end, a distal end, the shaft further comprising a conduit for fluid communication between the proximal end and distal end;

17. A kit for a drain clog remover according to claim 15 wherein the shaft further comprises a force to break of from about 10 lbs. to about 20 lbs.

18. A kit for a drain clog remover according to claim 15 wherein the shaft further comprises a peak bend force of from about 2 lbs. to about 4 lbs.

19. A kit for a drain clog remover according to claim 15 wherein the shaft further comprises a force to break of less than about 100 lbs.

20. A kit for a drain clog remover according to claim 19 wherein the shaft further comprises a force to break of from about 50 lbs. to about 100 lbs.
